(19) United States
(12) Patent Application Publication
(10) Pub. No.: US 2012/0211334 A1
(43) Pub. Date: Aug. 23, 2012

(54) CONVEYOR OVEN AND METHOD WITH IMPROVED DESIGN FOR INSTALLATION AND REMOVAL OF CONVEYOR ASSEMBLY

(75) Inventors: James R. Barnes, Huntington, IN (US); George Csadenyi, Fort Wayne, IN (US); Mark R. Farnbauch, Columbia City, IN (US); David L. Furge, Fort Wayne, IN (US); Christina M. Glaser, Runnemede, NJ (US); Chris Kelsaw, Fort Wayne, IN (US); Craig Oechsle, Fort Wayne, IN (US); P. Andrew Tyler, Roanoke, IN (US); Derek Walz, Leo, IN (US)

(73) Assignee: CLEVELAND RANGE, LLC.

(21) Appl. No.: 13/329,187

(22) Filed: Dec. 16, 2011

Related U.S. Application Data
(60) Provisional application No. 61/431,636, filed on Jan. 11, 2011.

(51) Int. Cl. B65G 17/30; B23P 11/00; B65G 35/00

(52) U.S. Cl. 198/844.2; 198/618; 29/426.1; 29/428

(57) ABSTRACT

A conveyor oven is provided that includes a conveyor assembly having an inlet section, and inner section and an outlet section. The conveyor assembly facilitates ease of removal by an enduser by allowing a single person to perform removal in a confined space.

### RELATED APPLICATION

This application claims priority of U.S. Provisional Patent Application No. 61/431,636, filed Jan. 11, 2011, the entire contents of which are incorporated herein by reference.

### BACKGROUND

1. Field of the Disclosure

The present disclosure relates to a conveyor oven. More specifically, the present disclosure relates to a conveyor oven and method that has an improved design to aid in installation and removal of the parts of the oven as, for example, the conveyor assembly.

2. Description of Related Art

In the market place today, end users of conveyor type ovens often have to consider conveyor removal and installation in their buying decision in order to accommodate physical constraints imposed by their kitchen layout that affects removal of parts for routine cleaning and maintenance. This factor is increasingly important for certain segments of the market since many end users are interested in kitchen layouts with smaller space constraints. In addition, distributors are looking to minimize their inventory of items while maintaining, or expanding, their base of potential customers for each application of the products they carry.

A conventional conveyor oven has a conveyor assembly, or conveyor assemblies, which must be removed either from the front of the oven or from either end of the conveyor oven. Furthermore, the conveyor assembly is often removed in one large section. Products that offer front removal of the conveyor assembly must be installed in an area where the layout has immediate space available. Products that offer removal of the conveyor assembly from the ends must provide adequate space towards the ends of the conveyor oven. In the case of larger conveyor ovens, the process of removing the conveyor assembly often requires the use of two people in order to avoid damage to the unit and to prevent unsafe working conditions.

Furthermore, the layout of other kitchen equipment surrounding the oven is an additional factor that must be considered when purchasing a conveyor oven. Due to space constraints inherent to some kitchen layouts, some kitchen layouts are better suited for removal of the conveyor from the front of the oven while other layouts are better suited for removal of the conveyor from the ends of the oven. This can often limit the selection of conveyors available for an enduser to purchase.

Thus, there is a need for a conveyor oven that can be easily installed and function in a wide range of kitchen layouts.

There is also a need for a conveyor oven, which allows for the installation and removal of the parts of a conveyor oven to be performed by one person.

### SUMMARY OF THE DISCLOSURE

The belt of the conveyor assembly has a splicing method for the belt which allows the end user to disconnect the belt without the aid of tools in a time period of under one minute after the release of a belt tension quick release tensioner assembly. Once the belt has been removed, the inner section(s) can be removed from the interior of the oven by picking the conveyor section vertically upwards and off of the alignment slots and support brackets located at the ends of each section. Larger ovens may require more than one interior conveyor section and thus may have additional alignment and support brackets located towards the inner portions of the oven. The drive end section for the conveyor may then be removed by first disengaging the drive mechanism and then rotating the conveyor upward and pushing downward so that the interlocking mechanism can be disengaged. This allows for the section to be removed from the oven at that time. The process is then repeated for the non-drive end section with the exception that no drive mechanism is present. The drive end and non-drive end sections include a leveling mechanism to maintain proper angular orientation of the conveyor with respect to the center section(s). These sections can be installed and removed in no particular order.

A conveyor oven according to an embodiment of the present disclosure comprises a housing that defines an oven chamber with at least one opening. A conveyor assembly is disposed in the oven to convey food products in the oven toward or away from the opening and is removably mounted to the housing. A fastening mechanism comprises a plurality of first portions affixed to the conveyor assembly and a like plurality of second portions affixed to the housing. The first and second portions comprise mating elements that removably mount the conveyor assembly to the housing.

A conveyor oven according to another embodiment of the present disclosure further comprises a door disposed on the housing that, when open, permits installation and removal of the conveyor assembly.

In a conveyor oven according to another embodiment of the present disclosure, the conveyor assembly comprises a first section and a second section. The first section is disposed in the oven and the fastening mechanism mounts the first section to the housing. The second section is disposed outside the oven chamber adjacent the opening. A second fastening mechanism comprises at least a first portion affixed to the housing and at least a second portion affixed to the second section. The first and second portions of the second fastening mechanism comprise mating elements that removably mount the second section to the housing adjacent the opening.

In a conveyor oven according to another embodiment of the present disclosure, the housing comprises a first opening corresponding to the at least one opening, and a second opening. The first section is disposed between the first and second openings. The conveyor assembly further comprises a third section that is disposed outside the oven chamber adjacent the second opening. A third fastening mechanism comprises at least a first portion affixed to the housing and at least a second portion affixed to the third section. The first and second portions of the third fastening mechanism comprise mating elements that removably mount the third section to the housing adjacent the second opening.

In a conveyor oven according to another embodiment of the present disclosure, the conveyor assembly further comprises a belt that is readily fastened to an endless condition and unfastened to a non-endless condition without a tool.

A method according to an embodiment of the present disclosure comprises removing a conveyor assembly from a conveyor oven that comprises a housing defining an oven chamber with at least one opening. The method comprises converting a belt of the conveyor assembly from an endless condition to a non-endless condition; removing the non-endless condition belt from the conveyor assembly; dislodging a plurality of portions of a fastening mechanism carried by the conveyor assembly from a plurality of mating fastening portions carried by the housing to free the conveyor assembly from the housing; and removing the freed conveyor assembly from the oven chamber.

In another embodiment of the method of the present disclosure, the belt of the conveyor assembly is converted from an endless condition to a non-endless condition without a tool.

A method according to another embodiment of the present disclosure comprises installing a conveyor assembly to a conveyor oven that comprises a housing defining an oven chamber with at least one opening. The method comprises: engaging a plurality of portions of a fastening mechanism carried by the conveyor assembly with a plurality of mating fastening portions carried by the housing to removably secure the conveyor assembly to the housing; and securing a belt to the conveyor assembly.

In another embodiment of the method of the present disclosure, the belt in a non-endless condition is wrapped about the conveyor assembly and then converted to an endless condition.

In another embodiment of the method of the present disclosure, the engaging step comprises: engaging a first plurality of portions of a first fastening mechanism carried by a first section of the conveyor assembly in the oven with a first plurality of mating fastening portions carried by the housing to removably secure the first section to the housing in the oven chamber; and engaging at least one second portion of a second fastening mechanism carried by a second section of the conveyor assembly with at least one second mating portion of the second fastening mechanism carried by the housing to removably secure the second section to the housing outside the oven chamber adjacent the opening.

In another embodiment of the method of the present disclosure, the housing further defines a second opening of the oven chamber. The engaging step further comprises engaging at least a third portion of a third fastening mechanism carried by a third section of the conveyor assembly with at least a third mating portion of the third fastening mechanism carried by the housing to removably secure the third section to the housing outside the oven chamber adjacent the second opening.

### BRIEF DESCRIPTION OF THE DRAWINGS

Other and further benefits, advantages and features of the present invention will be understood by reference to the following specification in conjunction with the accompanying drawings, in which like reference characters denote like elements of structure and:

FIG. 1 is a perspective view of a conveyor oven of the present disclosure;

FIG. 2 is a front view of the conveyor oven of FIG. 1;

FIG. 3 is a view of detail A of FIG. 2;

FIG. 4 is a view of detail B of FIG. 1; and

FIG. 5 is a front view of the conveyor oven of FIG. 1 with the middle conveyor section elevated.

### DETAILED DESCRIPTION OF THE PREFERRED EMBODIMENT

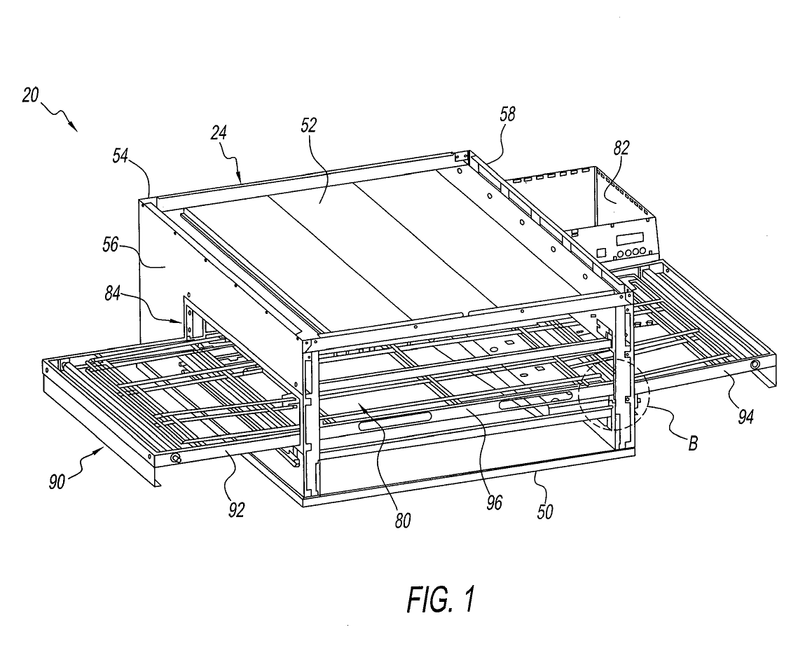

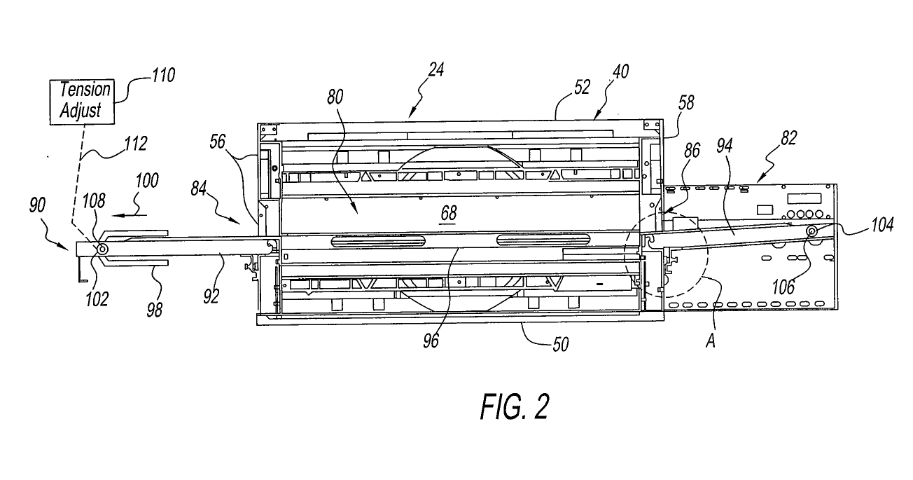

Referring to FIGS. 1 and 2, a conveyor oven 20 according to the present disclosure comprises a housing 24, which preferably has a box structure. Housing 24 comprises a bottom cap 50, a top cap 52, a back wall 54, a left side wall 56 and a right side wall 58. Bottom cap 50 is fastened to left side wall 56 and right side wall 58 at locations near their respective bottoms. Top cap 52 is fastened to left side wall 56 and right side wall 58. Back wall 54 is fastened to right side wall 58 and left side wall 56 near their respective rears. A door (not shown) is attached to the front of housing 24. For example, the door can be attached with hinges to a front top rail 40 and/or to left side wall 56 and right side wall 58.

Referring to FIGS. 1 and 2, conveyor oven 20 further comprises an oven chamber 80 disposed to the front of an interior divider wall 68 and a chamber 82 disposed between interior divider wall 68 and back wall 54. A thermal source, a blower and ductwork (none of which is shown on the drawing) are disposed in chamber 82. The blower circulates heated air among oven chamber 80 and chamber 82 via the ductwork. The circulating air is heated by the thermal source, which can be any suitable heater that heats the circulating air. For example, the thermal source may be a gas burner, electric heater or other thermal source. Chamber 82 extends beyond right side wall 58 to accommodate a gas burner.

As shown in FIGS. 1 and 2, conveyor oven 20 is adapted for use on a flat surface above a floor, for example, a table top, a counter top a shelf or other flat surface. In other embodiments conveyor oven 20 may have legs or other supporting structure for stand-alone use on a floor.

A left port or opening 84 is located in left side wall 56 and a right port or opening 86 is located in right side wall 58 in alignment with oven chamber 80. A conveyor assembly 90 is partly disposed within oven chamber 80 and partly outside of oven chamber 80. To this end, conveyor assembly 90 extends through left and right openings 84 and 86 for the loading and removal of food products.

Conveyor assembly 90 comprises a belt 98, a left section 92, a right section 94 and an interior section 96. Belt 98 has an endless condition or configuration and a non-endless condition or configuration. In the endless configuration, belt 98 extends around left section 92, interior section 96 and right section 94. Belt 98 is driven by any suitable motive device and linkage to convey food through oven chamber 80 in a direction to enter via one of left and right openings 84 and 86 and exit via the other. For example, if belt 98 is driven in the direction denoted by arrow 100 in FIG. 2, the food would enter oven chamber 80 via right opening 86 and exit via left opening 84. Belt 98 is disposed around a wheel 102 in left section 92 and around a wheel 104 in right section 94. Wheel 104 is mounted on an axle 106, which is driven by a motor (not shown) to impart motion of belt 98 in the direction shown by arrow 100. Wheel 102 is mounted on an axle 108, which is an idle axle (i.e., not a driven axle). In other embodiments, the roles of wheels 102 and 104 may be reversed with wheel 102 being the driven wheel 102 and wheel 104 being the idle wheel.

As mentioned above, conveyor assembly 90 is removable by one person in a very short time for the purpose of cleaning, service, maintenance or other purpose. This is a result of features that are included in conveyor oven 20. These features include the separate independent sections 92, 94 and 96 and the manner of their connections to housing 24 and belt 98 and its mounting and disengagement from wheels 102 and 104.

A tension adjuster 110 is connected via a linkage 112 that moves axle 108 back and forth along the length of belt 98. Tension adjuster 110 in some designs is operated manually by the end user to provide a quick release of tension of belt 98. The range of motion is large enough to loosen belt 98 from wheel 102 to an extent that allows belt 98 to become disengaged from wheel 92.

Conveyor belt 98 is assembled with a splicing technique into the endless configuration. The splicing technique allows an end user to convert belt 98 from the endless configuration to the non-endless configuration by disconnecting the splice without the aid of tools in a very short time, for example, about one minute or less. An example of this belting is the EZ splice belting of the Wire Belt Company of America. This belt can be quickly removed by pulling the two belt sides together at the splice and rotating the “hooked” belt section out of the other belt section.

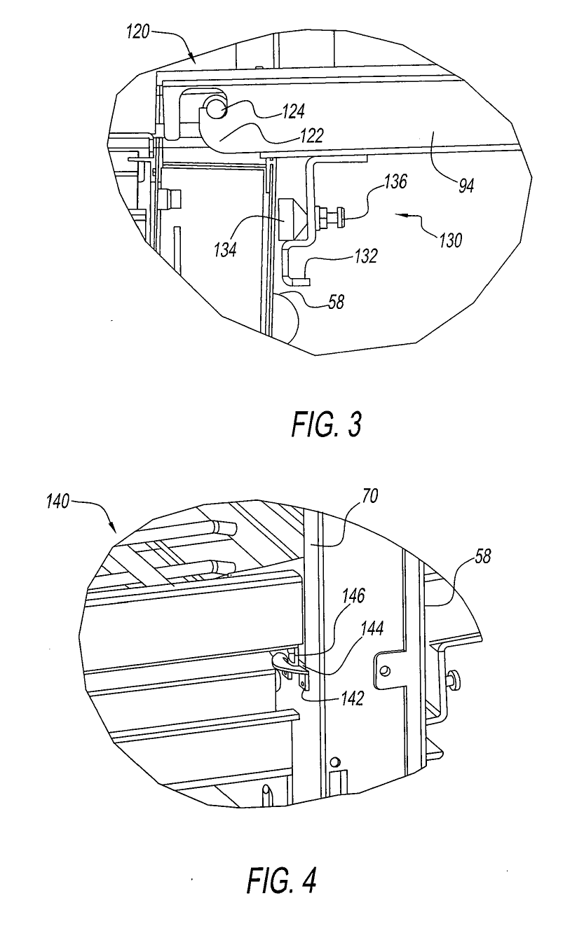

Turning to the mounting on housing 24 of conveyor assembly 90, left section 92 is mounted to left side wall 56 and right section 94 is mounted to right side wall 58 with interlock mechanisms that allow quick disconnects by an end user. It will be appreciated that the interlock mechanisms are each mounted at the same level or height. As the interlock mechanisms for left section 92 and right section 94 are the same, only the interlock mechanism for right section 94 shown at detail A in FIG. 2 and in more detail in FIG. 3 will be described.

Referring to FIG. 3, an interlock mechanism 120 comprises a slot 122 formed in an end of right section 94 of conveyor assembly 90 and a post 124 formed or attached to right side wall 58. A similar interlock mechanism is provided for the opposite side of right section 94 and right side wall 58. To install right section 94 to housing 24, right section 94 is oriented toward the vertical so that the slots 122 are brought into engagement with posts 124 of right side wall 58. Slots 122 preferably have a shape that retains or interlocks posts 124 when right section 94 is rotated to its installed position shown in FIGS. 1-3. Although many such shapes are possible, a preferred shape is an upside down J-shaped slot in which post 122 fits in the crook of the J.

To remove right section 94 (after belt 98 has been removed), the end user disengages the drive mechanism and merely rotates right section 94 upward and pushes downward to disengage the interlock (i.e., until post 124 disengages from slot 122) and then pulls right section 94 away from conveyor oven 20. It will be appreciated that left section 92 is similarly quickly installed to and removed from left side wall 56 except that left section 92 has no drive mechanism. As noted previously, for removal, belt 98 must be removed by reducing belt tension with tension adjuster 110. Then belt 98 is despliced and removed by pulling it off conveyor assembly 20. For installation, belt 98 is threaded around wheels 102 and 104 and then spliced. Tension adjuster 110 is then operated to bring belt 98 to the proper tension for cooking.

Still referring to FIGS. 1-3, a leveling mechanism 130 maintains proper angular orientation of the conveyor left and right sections 92 and 94 with respect to interior section 96. Leveling mechanism 130 comprises a bracket 132 affixed to a bottom side of right section 94. Bracket 132 carries a plunger 134 with an adjustable knob 136. Knob 136 is manually adjustable by an end user to change the angular orientation of right section 94 of conveyor assembly 90. Plunger 134 is in contact with right side wall 58 so that as knob 136 is turned, right section 94 rotates upwardly or downwardly based on the turning direction of knob 136. A like leveling mechanism 130 is provided for the opposite side of right section 94. Like leveling mechanisms 130 are provided on left front section 92 to maintain proper angular orientation of left section 92 with interior section 96 of conveyor assembly 90.

Interior section 96 is mounted to housing 24 with a fastening mechanism 140 shown at detail B in FIG. 1 and in an expanded view in FIG. 4. There are four fastening mechanisms 140, one for each corner of interior section 96 and corresponding locations of left side wall 56 and right side wall 58. As the four fastening mechanisms 140 are identical, only the fastening mechanism 140 that fastens the right front corner of interior section 96 to right side wall 58 will be described.

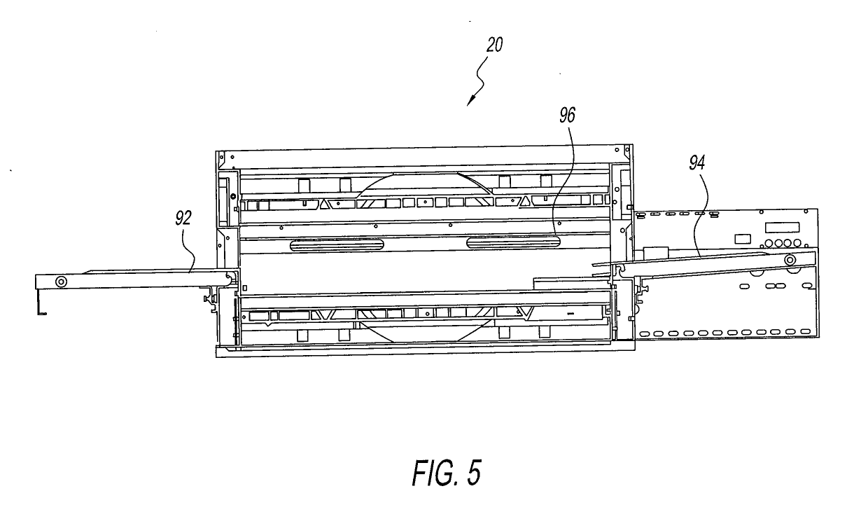

Referring to FIGS. 1 and 4, fastening mechanism 140 comprises a slot portion 142 that is affixed to an inner wall frame 70. Slot portion 142 comprises a slot 144. Fastening mechanism 140 also comprises a tab 146 that is mounted to a bottom of interior section 96 and that extends vertically downward at a location where it will mate with slot 144 of slot portion 142 on inner wall frame 70. To install interior section 96 of conveyor assembly to housing 24, interior section 96 is moved inside oven chamber 80 via an open door with its tabs 146 extending downward from its four corners and then lowered into registration with slots 144 of left side inner wall frame 70 and right side inner wall frame 70. To remove interior section 96 from conveyor assembly 90, the door is opened and interior section 96 is lifted upwardly to disengage fastening mechanisms 140 (i.e., until tabs 146 are clear of their respective slots 144) and then moved out of oven chamber 80 via the open door. FIG. 5 shows interior section 96 in an elevated position prior to engagement with or after disengagement from fastening mechanisms 140.

Consequently, cleaning and maintaining the oven 10 is simplified because the orientation of the oven 10 does not hinder access by maintenance and cleaning personnel.

The present disclosure having been thus described with particular reference to the preferred forms thereof, it will be obvious that various changes and modifications may be made therein without departing from the spirit and scope of the present disclosure as defined in the appended claims.

What is claimed is:

1. A conveyor oven comprising:
a housing defining an oven chamber with at least one opening;
a conveyor assembly that is disposed in said oven to convey food products in said oven toward or away from said opening and that is removably mounted to said housing; and
a fastening mechanism comprising a plurality of first portions affixed to said conveyor assembly and a like plurality of second portions affixed to said housing, and wherein said first and second portions comprise mating elements that removably mount said conveyor assembly to said housing.

2. The conveyor oven of claim 1, further comprises a door disposed on said housing that, when open, permits installation and removal of said conveyor assembly.

3. The conveyor oven of claim 1, wherein said conveyor assembly comprises a first section and a second section, wherein said first section is disposed in said oven and said fastening mechanism mounts said first section to said housing, and wherein said second section is disposed outside said oven chamber adjacent said opening, and
a second fastening mechanism comprises at least a first portion affixed to said housing and at least a second portion affixed to said second section, and wherein said first and second portions of said second fastening mechanism comprise mating elements that removably mount said second section to said housing adjacent said opening.

4. The conveyor oven of claim 3, wherein said housing comprises a first opening corresponding to said at least one opening, and a second opening, wherein said first section is disposed between said first and second openings, wherein said conveyor assembly further comprises a third section that is disposed outside said oven chamber adjacent said second opening, and further comprising a third fastening mechanism that comprises at least a first portion affixed to said housing and at least a second portion affixed to said third section, and wherein said first and second portions of said third fastening mechanism comprise mating elements that removably mount said third section to said housing adjacent said second opening.

5. The conveyor oven of claim 1, wherein said conveyor assembly further comprises a belt that is readily fastened to an endless condition and unfastened to a non-endless condition without a tool.

6. A method of removing a conveyor assembly from a conveyor oven that comprises a housing defining an oven chamber with at least one opening, said method comprising:
converting a belt of said conveyor assembly from an endless condition to a non-endless condition;
removing said non-endless condition belt from said conveyor assembly;
dislodging a plurality of portions of a fastening mechanism carried by said conveyor assembly from a plurality of mating fastening portions carried by said housing to free said conveyor assembly from said housing; and
removing said freed conveyor assembly from said oven chamber.

7. The method of claim 6, wherein said belt of said conveyor assembly is converted from an endless condition to a non-endless condition without a tool.

8. A method of installing a conveyor assembly to a conveyor oven that comprises a housing defining an oven chamber with at least one opening, said method comprising:
engaging a plurality of portions of a fastening mechanism carried by said conveyor assembly with a plurality of mating fastening portions carried by said housing to removably secure said conveyor assembly to said housing; and
securing a belt to said conveyor assembly.

9. The method of claim 8, wherein said belt in a non-endless condition is wrapped about said conveyor assembly and then converted to an endless condition.

10. The method of claim 8, wherein said engaging step comprises:
engaging a first plurality of portions of a first fastening mechanism carried by a first section of said conveyor assembly in said oven with a first plurality of mating fastening portions carried by said housing to removably secure said first section to said housing in said oven chamber; and
engaging at least one second portion of a second fastening mechanism carried by a second section of said conveyor assembly with at least one second mating portion of said second fastening mechanism carried by said housing to removably secure said second section to said housing outside said oven chamber adjacent said opening.

11. The method of claim 10, wherein said housing further defines a second opening of said oven chamber, and wherein said engaging step further comprises:
engaging at least a third portion of a third fastening mechanism carried by a third section of said conveyor assembly with at least a third mating portion of said third fastening mechanism carried by said housing to removably secure said third section to said housing outside said oven chamber adjacent said second opening.
